(19) United States
(12) Patent Application Publication
(10) Pub. No.: US 2025/0056417 A1
(43) Pub. Date: Feb. 13, 2025

(54) POWER CLASS SWITCHING MODES

(71) Applicant: QUALCOMM Incorporated, San Diego, CA (US)

(72) Inventors: Gokul SRIDHARAN, Sunnyvale, CA (US); Sumant Jayaraman IYER, San Diego, CA (US); Kazuki TAKEDA, Tokyo (JP); Peter GAAL, San Diego, CA (US)

(21) Appl. No.: 18/781,608

(22) Filed: Jul. 23, 2024

Related U.S. Application Data
(60) Provisional application No. 63/519,122, filed on Aug. 11, 2023.

(51) Int. Cl. H04W 52/14; H04W 52/36

(52) U.S. Cl. CPC H04W 52/146; H04W 52/367

(57) ABSTRACT

Various aspects of the present disclosure generally relate to wireless communication. In some aspects, a user equipment (UE) may transmit, to a network node, capability information indicating a set of uplink transmission capabilities. The UE may transmit, to the network node, an indication of a power class switch from a first power class associated with a first uplink transmission power to a second power class associated with a second uplink transmission power. The UE may transmit, to the network node, an indication of a power class switching mode associated with the power class switch. The UE may transmit, to the network node, an uplink transmission based at least in part on one or more revised uplink transmission capabilities, from the set of uplink transmission capabilities, associated with the power class switching mode. Numerous other aspects are described.

### CROSS-REFERENCE TO RELATED APPLICATION

This patent application claims priority to U.S. Provisional Patent Application No. 63/519,122, filed on Aug. 11, 2023, entitled “POWER CLASS SWITCHING MODES,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for power class switching modes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be individually or collectively configured to transmit, to a network node, capability information indicating a set of uplink transmission capabilities. The one or more processors may be individually or collectively configured to transmit, to the network node, an indication of a power class switch from a first power class associated with a first uplink transmission power to a second power class associated with a second uplink transmission power. The one or more processors may be individually or collectively configured to transmit, to the network node, an indication of a power class switching mode associated with the power class switch. The one or more processors may be individually or collectively configured to transmit, to the network node, an uplink transmission based at least in part on one or more revised uplink transmission capabilities, from the set of uplink transmission capabilities, associated with the power class switching mode.

Some aspects described herein relate to a network node for wireless communication. The network node may include one or more memories and one or more processors coupled to the one or more memories. The one or more processors may be individually or collectively configured to receive, from a UE, capability information indicating a set of uplink transmission capabilities. The one or more processors may be individually or collectively configured to receive, from the UE, an indication of a power class switch from a first power class associated with a first uplink transmission power to a second power class associated with a second uplink transmission power. The one or more processors may be individually or collectively configured to receive, from the UE, an indication of a power class switching mode associated with the power class switch. The one or more processors may be individually or collectively configured to receive, from the UE, an uplink transmission based at least in part on one or more revised uplink transmission capabilities, from the set of uplink transmission capabilities, associated with the power class switching mode.

Some aspects described herein relate to a method of wireless communication performed by a UE. The method may include transmitting, to a network node, capability information indicating a set of uplink transmission capabilities. The method may include transmitting, to the network node, an indication of a power class switch from a first power class associated with a first uplink transmission power to a second power class associated with a second uplink transmission power. The method may include transmitting, to the network node, an indication of a power class switching mode associated with the power class switch. The method may include transmitting, to the network node, an uplink transmission based at least in part on one or more revised uplink transmission capabilities, from the set of uplink transmission capabilities, associated with the power class switching mode.

Some aspects described herein relate to a method of wireless communication performed by a network node. The method may include receiving, from a UE, capability information indicating a set of uplink transmission capabilities. The method may include receiving, from the UE, an indication of a power class switch from a first power class associated with a first uplink transmission power to a second power class associated with a second uplink transmission power. The method may include receiving, from the UE, an indication of a power class switching mode associated with the power class switch. The method may include receiving, from the UE, an uplink transmission based at least in part on one or more revised uplink transmission capabilities, from the set of uplink transmission capabilities, associated with the power class switching mode.

Some aspects described herein relate to a non-transitory computer-readable medium that stores a set of instructions for wireless communication by a UE. The set of instructions, when executed by one or more processors of the UE, may cause the UE to transmit, to a network node, capability information indicating a set of uplink transmission capabilities. The set of instructions, when executed by one or more processors of the UE, may cause the UE to transmit, to the network node, an indication of a power class switch from a first power class associated with a first uplink transmission power to a second power class associated with a second uplink transmission power. The set of instructions, when executed by one or more processors of the UE, may cause the UE to transmit, to the network node, an indication of a power class switching mode associated with the power class switch. The set of instructions, when executed by one or more processors of the UE, may cause the UE to transmit, to the network node, an uplink transmission based at least in part on one or more revised uplink transmission capabilities, from the set of uplink transmission capabilities, associated with the power class switching mode.

Some aspects described herein relate to a non-transitory computer-readable medium that stores a set of instructions for wireless communication by a network node. The set of instructions, when executed by one or more processors of the network node, may cause the network node to receive, from a UE, capability information indicating a set of uplink transmission capabilities. The set of instructions, when executed by one or more processors of the network node, may cause the network node to receive, from the UE, an indication of a power class switch from a first power class associated with a first uplink transmission power to a second power class associated with a second uplink transmission power. The set of instructions, when executed by one or more processors of the network node, may cause the network node to receive, from the UE, an indication of a power class switching mode associated with the power class switch. The set of instructions, when executed by one or more processors of the network node, may cause the network node to receive, from the UE, an uplink transmission based at least in part on one or more revised uplink transmission capabilities, from the set of uplink transmission capabilities, associated with the power class switching mode.

Some aspects described herein relate to an apparatus for wireless communication. The apparatus may include means for transmitting, to a network node, capability information indicating a set of uplink transmission capabilities. The apparatus may include means for transmitting, to the network node, an indication of a power class switch from a first power class associated with a first uplink transmission power to a second power class associated with a second uplink transmission power. The apparatus may include means for transmitting, to the network node, an indication of a power class switching mode associated with the power class switch. The apparatus may include means for transmitting, to the network node, an uplink transmission based at least in part on one or more revised uplink transmission capabilities, from the set of uplink transmission capabilities, associated with the power class switching mode.

Some aspects described herein relate to an apparatus for wireless communication. The apparatus may include means for receiving, from a UE, capability information indicating a set of uplink transmission capabilities. The apparatus may include means for receiving, from the UE, an indication of a power class switch from a first power class associated with a first uplink transmission power to a second power class associated with a second uplink transmission power. The apparatus may include means for receiving, from the UE, an indication of a power class switching mode associated with the power class switch. The apparatus may include means for receiving, from the UE, an uplink transmission based at least in part on one or more revised uplink transmission capabilities, from the set of uplink transmission capabilities, associated with the power class switching mode.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4C are diagrams illustrating examples of power class fallback modes, in accordance with the present disclosure.

FIG. 5 is a diagram of an example associated with power class switching modes, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network node or an apparatus of a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

A maximum transmission power for a user equipment (UE) may be defined by a power class of the UE. In some examples, a UE may support a higher power class than a default power class for a frequency band. In such examples, the UE may indicate (e.g., via UE capability information) a maximum duty cycle for which the UE is able to sustain transmission power levels associated with the higher power class for uplink transmissions. The maximum duty cycle may be a maximum percentage of uplink symbols in which the UE can transmit while operating using the higher power class. When uplink scheduling configured or received by the UE exceeds the maximum duty cycle (e.g., the percentage of uplink symbols in which uplink transmissions are scheduled exceeds the maximum duty cycle) in a certain evaluation period (e.g., an evaluation period no less than one radio frame), the UE is permitted to fallback to operating using a lower power class.

Enabling a UE to fall back from a higher power class to a lower power class may reduce thermal issues, user safety issues, and/or damage to RF components of the UE that may result from sustained transmission at the higher transmission power associated with the higher power class. However, one or more uplink transmission capabilities of the UE may change in connection with a fallback from higher power class to a lower power class. In some examples, the changes to the uplink transmission capabilities of the UE may depend on how the UE performs the fallback from the higher power class to the lower power class. A network node, when performing scheduling of uplink communications to be transmitted by the UE, may not be aware of changes in uplink transmission capabilities of the UE resulting from a power class fallback. This may result in decreased network performance, including increased traffic latency and decreased network reliability.

Various aspects relate generally to a UE switching from one power class to another power class. Some aspects more specifically relate to power class switching modes (e.g., power class fallback modes) and uplink transmission capabilities associated with the power class switching modes. In some aspects, a UE may transmit, to a network node, capability information indicating a set of uplink transmission capabilities for the UE. The UE may transmit, to the network node, an indication of a power class switch from a first power class to a second power class. In some examples, the power class switch may a power class fallback from a first power class associated with a first uplink transmission power to a second power class associated with a second uplink transmission power that is lower than the first uplink transmission power. The UE may transmit, to the network node, an indication of a power class switching mode (e.g., a power class fallback mode) associated with the power class switch. In some examples, the indication of the power class switching mode may be included in the capability information. In some other examples, the indication of the power class switching mode may be included in a same transmission or communication as the indication of the power class switch. The UE may transmit an uplink transmission based at least in part on one or more revised uplink transmission capabilities, from the set of uplink transmission capabilities, associated with the power class switching mode. In some examples, the capability information may indicate the one or more revised uplink transmission capabilities. For example, the capability information may indicate respective sets of uplink transmission capabilities for one or more power class switching modes (e.g., power class fallback modes) supported by the UE. In some other examples, the one or more revised uplink transmission capabilities may be indicated in the same transmission or communication as the indication of the power class switch.

Particular aspects of the subject matter described in this disclosure can be implemented to realize one or more of the following potential advantages. In some examples, by enabling the UE to report an indication of the power class switching mode associated with a power class switch and transmit an uplink transmission based at least in part on revised transmission capabilities associated with the power class switching mode, the described techniques can be used to improve scheduling of uplink transmissions and network performance, resulting in decreased traffic latency and increased network reliability. In some examples, by including the indication of the power class switching mode and/or the revised uplink transmission capabilities associated with the power class switching mode in the capability information, signaling overhead may be reduced as compared with dynamically indicating the power class switching mode and/or the revised uplink transmission capabilities. In some other examples, by dynamically indicating the power class switching mode and/or the revised uplink transmission capabilities in a same transmission or communication as the indication of the power class switch, flexibility may be increased as compared with a static indication of the power class switching mode and/or the revised uplink transmission capabilities in the capability information.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

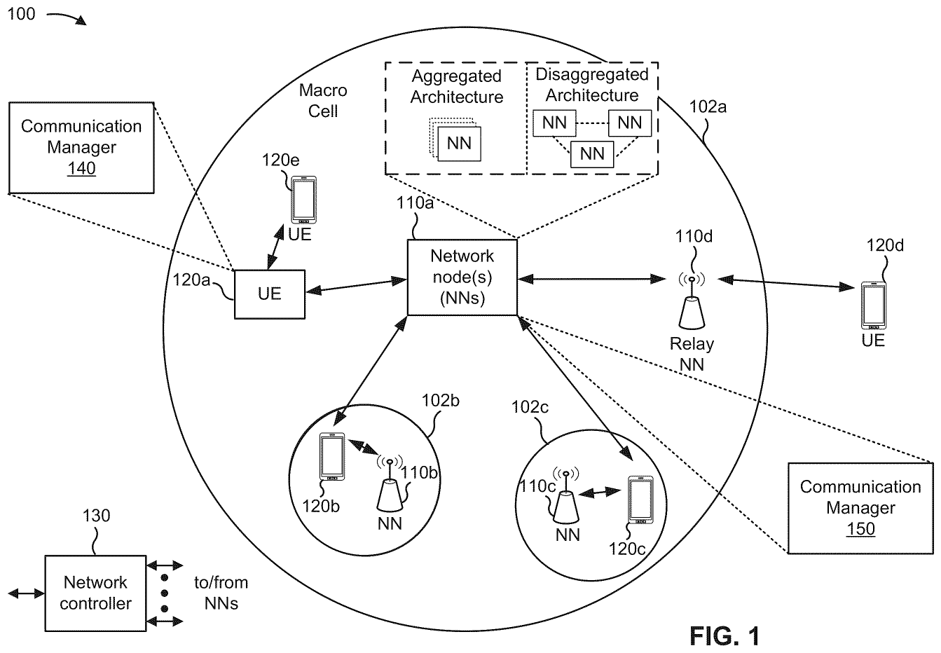

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network node, capability information indicating a set of uplink transmission capabilities; transmit, to the network node, an indication of a power class switch from a first power class associated with a first uplink transmission power to a second power class associated with a second uplink transmission power; transmit, to the network node, an indication of a power class switching mode associated with the power class switch; and transmit, to the network node, an uplink transmission based at least in part on one or more revised uplink transmission capabilities, from the set of uplink transmission capabilities, associated with the power class switching mode. Additionally, or alternatively, the communication manager 140 may perform one or more other operations described herein.

In some aspects, the network node 110 may include a communication manager 150. As described in more detail elsewhere herein, the communication manager 150 may receive, from a UE, capability information indicating a set of uplink transmission capabilities; receive, from the UE, an indication of a power class switch from a first power class associated with a first uplink transmission power to a second power class associated with a second uplink transmission power; receive, from the UE, an indication of a power class switching mode associated with the power class switch; and receive, from the UE, an uplink transmission based at least in part on one or more revised uplink transmission capabilities, from the set of uplink transmission capabilities, associated with the power class switching mode. Additionally, or alternatively, the communication manager 150 may perform one or more other operations described herein.

As indicated above, FIG. 1 is provided as an example. Other examples may differ from what is described with regard to FIG. 1.

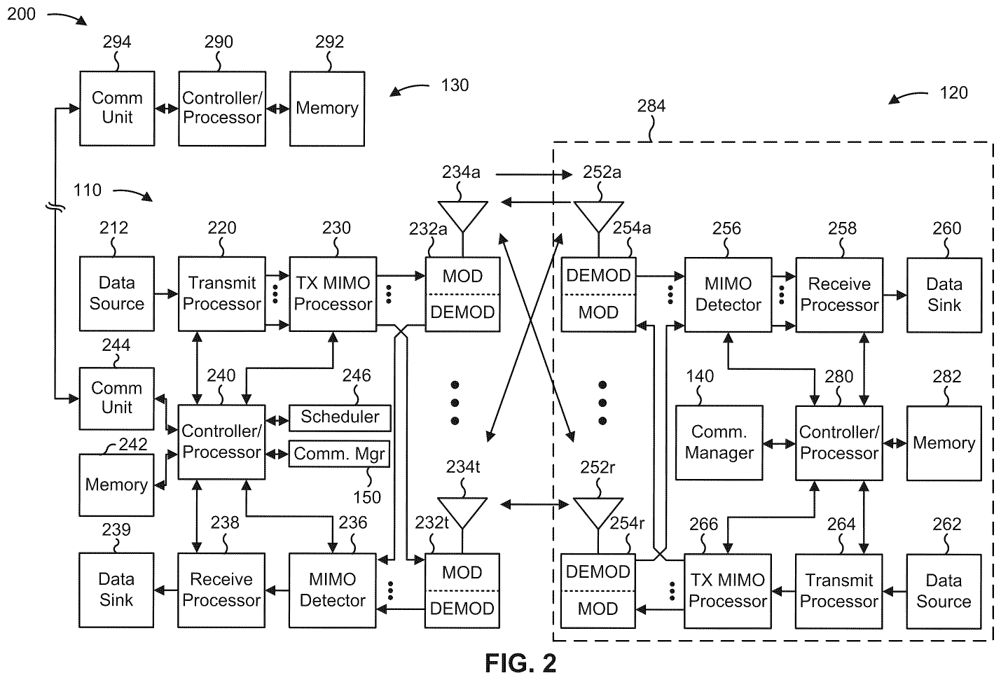

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

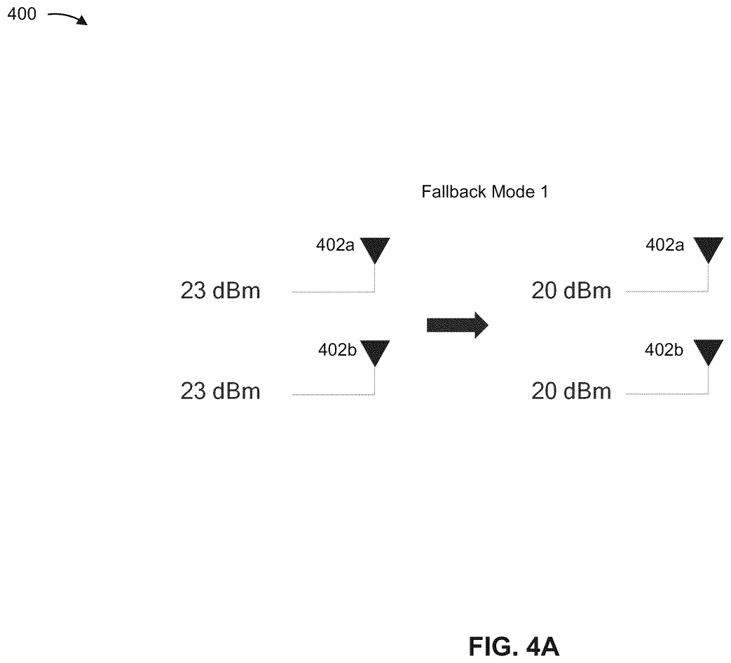

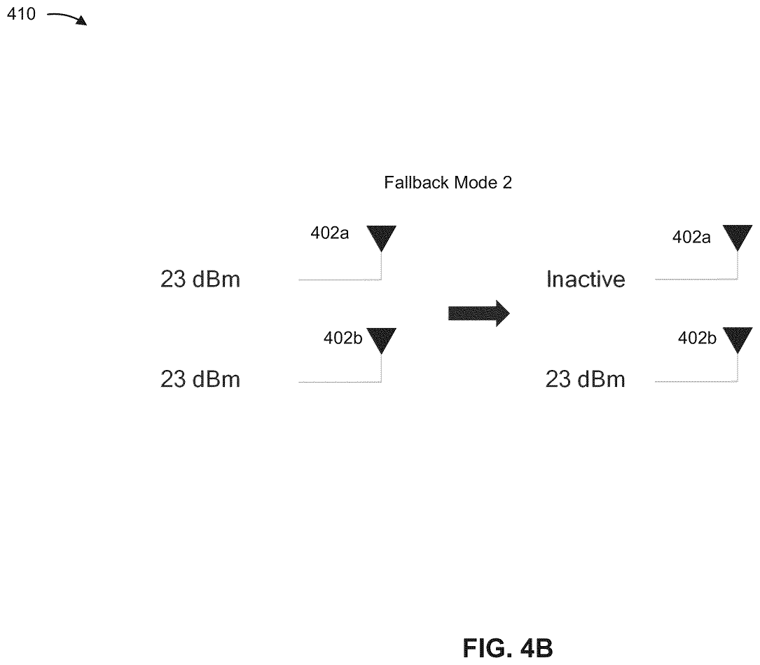

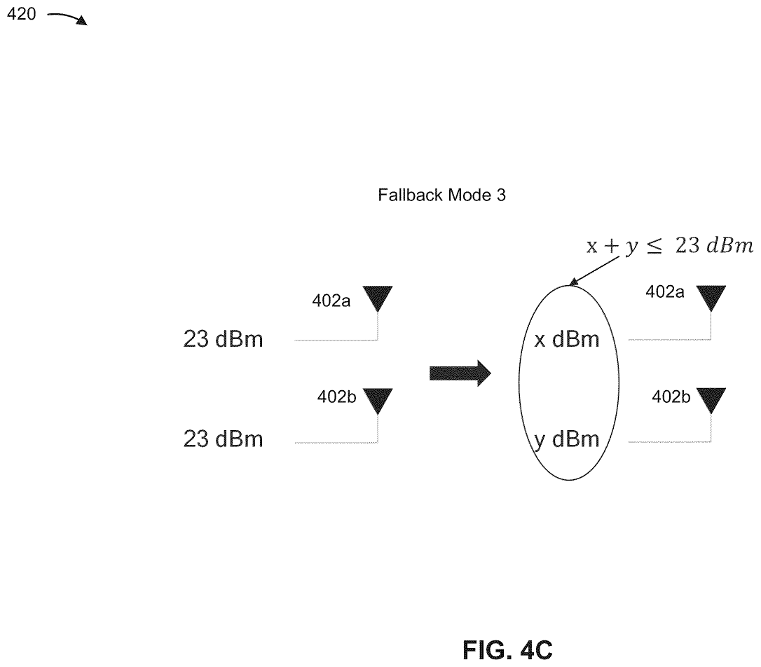

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-4C and 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-4C and 5-9).

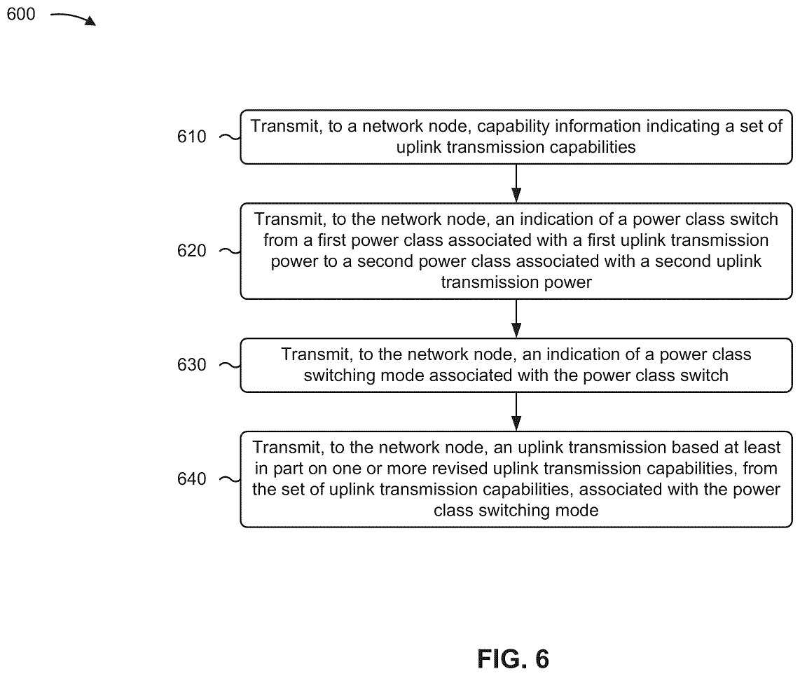

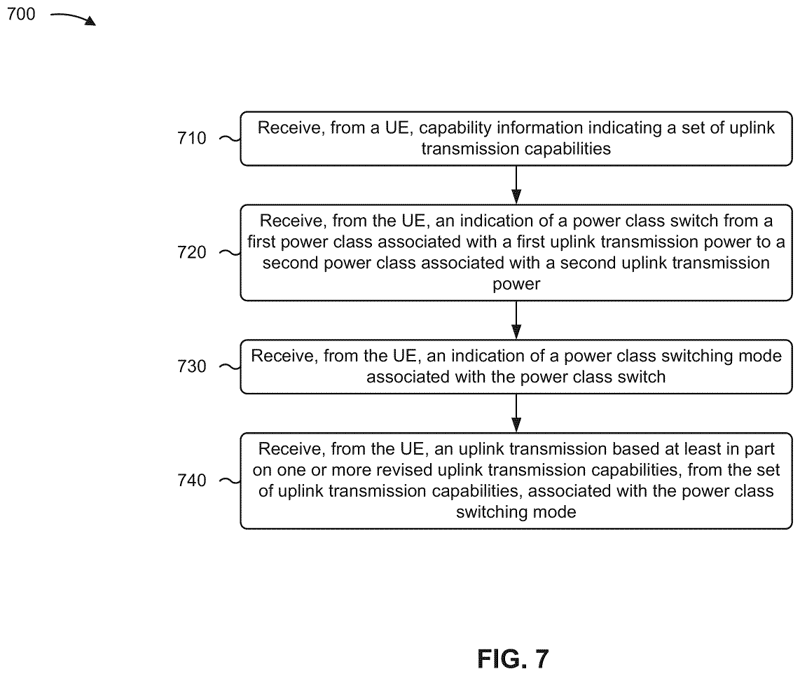

The controller/processor 240 of the network node 110, the controller/processor 280 of the UE 120, and/or any other component(s) of FIG. 2 may perform one or more techniques associated with power class switching modes, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to a network node, capability information indicating a set of uplink transmission capabilities; means for transmitting, to the network node, an indication of a power class switch from a first power class associated with a first uplink transmission power to a second power class associated with a second uplink transmission power; means for transmitting, to the network node, an indication of a power class switching mode associated with the power class switch; and/or means for transmitting, to the network node, an uplink transmission based at least in part on one or more revised uplink transmission capabilities, from the set of uplink transmission capabilities, associated with the power class switching mode. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from a UE, capability information indicating a set of uplink transmission capabilities; means for receiving, from the UE, an indication of a power class switch from a first power class associated with a first uplink transmission power to a second power class associated with a second uplink transmission power; means for receiving, from the UE, an indication of a power class switching mode associated with the power class switch; and/or means for receiving, from the UE, an uplink transmission based at least in part on one or more revised uplink transmission capabilities, from the set of uplink transmission capabilities, associated with the power class switching mode. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

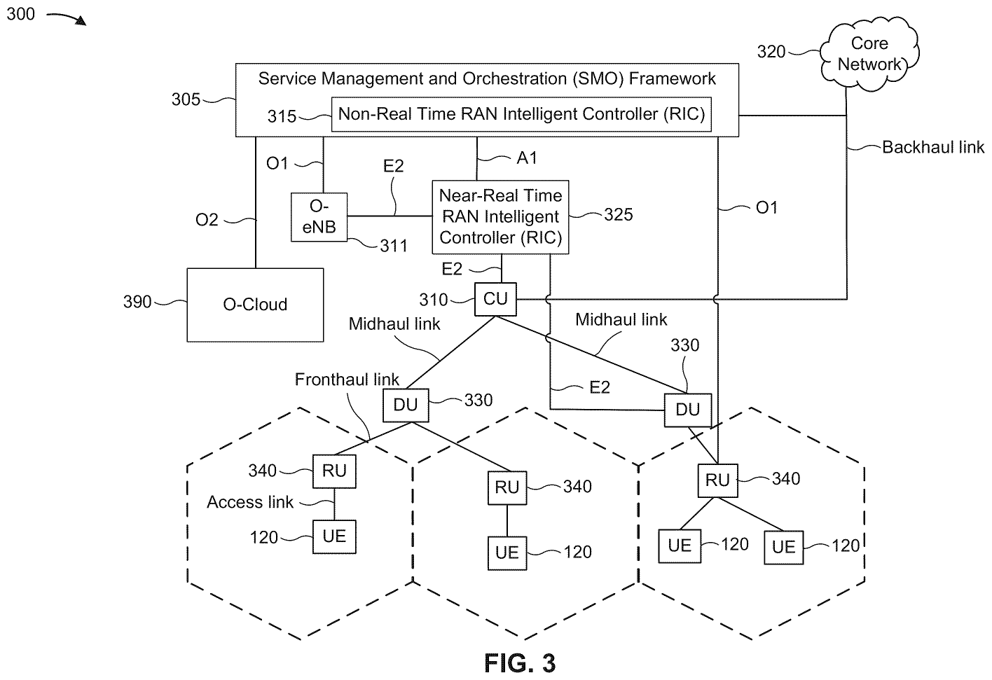

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

In some examples, a maximum transmission power for a UE may be defined by a power class of the UE. In NR, a UE power class corresponds to a maximum transmit power over the NR channel bandwidth (e.g., the bandwidth of the channel on which the UE 120 is performing transmission). In some examples, power classes specified by wireless communication standard (e.g., a 3GPP standard) for communication in a frequency range (e.g., FR1) may include a power class 2 (PC2) and a power class 3 (PC3). PC2 may be associated with a maximum uplink transmission power of 26 dBm, and PC3 may be associated with a maximum uplink transmission power of 23 dBm. Additionally, or alternatively, a power class 1.5 (PC1.5) may be specified by a wireless communication standard (e.g., a 3GPP standard) for communication in a frequency range (e.g., FR1). PC1.5 may be associated with a maximum uplink transmission power of 29 dBm.

In some examples, a UE may support a higher power class (e.g., PC2 or PC1.5) than a default power class (e.g., PC3) for a frequency band. In such examples, the UE may indicate (e.g., via UE capability information) a maximum duty cycle for which the UE is able to sustain transmission power levels associated with the higher power class for uplink transmissions. The maximum duty cycle may be a maximum percentage of uplink symbols in which the UE can transmit while operating using the higher power class. For example, a PC2 UE may indicate the maximum duty cycle via a maxUplinkDutyCycle-PC2-FR1 parameter in a UE capability report. In another example, a PC1.5 UE may indicate the maximum duty cycle via a maxUplinkDutyCycle-PC1dot5-MPR-FR1 parameter in a UE capability report. If the maximum duty cycle parameter (e.g., maxUplinkDutyCycle-PC2-FR1 or maxUplinkDutyCycle-PC1dot5-MPR-FR1) is not included in the UE capability report, a default maximum duty cycle (e.g., 50%) may be assumed. In some examples, when uplink scheduling configured or received by the UE exceeds the maximum duty cycle (e.g., the percentage of uplink symbols in which uplink transmissions are scheduled exceeds the maximum duty cycle) in a certain evaluation period (e.g., an evaluation period no less than one radio frame), the UE is permitted to fall back to operating using a lower power class (e.g., PC3). For example, a PC2 UE may fall back to operating as a PC3 UE in connection with a determination the maximum duty cycle has been exceeded. Similarly, a PC1.5 UE may fall back to operating as PC3 UE (or fallback to operating as a PC2 UE) in connection with a determination the maximum duty cycle has been exceeded. Enabling a UE to fall back from a higher power class to a lower power class may reduce thermal issues, user safety issues, and/or damage to RF components of the UE that may result from sustained transmission at the higher transmission power associated with the higher power class.

In some cases, it may not be clear to a network node when a UE performs a fallback from a higher power class to a lower power class. For example, the UE may consider the percentage of uplink symbols transmitted in a certain evaluation period to determine whether to continue operating using the higher power class (e.g., PC2 or PC1.5) or fall back to the lower power class (e.g., PC3), but the evaluation period may not be known to the network node. For example, a UE evaluating uplink transmissions over an evaluation period of a first duration (e.g., one radio frame) may behave differently as compared with a UE evaluating uplink transmissions over an evaluation period of a second duration (e.g., two radio frames). In some examples, a UE may report a power class fallback to the network node. For example, the UE may report the power class fallback via a parameter (e.g., ΔP_{PowerClass}) that indicates a switch (e.g., fallback) from one power class to another power class. In some examples, the UE may transmit the parameter (e.g., ΔP_{PowerClass}) to report the power class fallback only when the configured maximum duty cycle is exceeded. For example, the UE may include the parameter (e.g., ΔP_{PowerClass}) indicating the power class fallback in a power headroom report (PHR) in connection with a determination that the maximum duty cycle is exceeded in a certain evaluation period.

In some cases, one or more uplink transmission capabilities of the UE may change in connection with a fallback from higher power class to a lower power class. In some aspects, the reporting of the power class fallback (e.g., via ΔP_{PowerClass}) may provide the UE with an opportunity to revise one or more uplink transmission capabilities reported by the UE. For example, the reporting of the power class fallback can be combined with full-power MIMO transmission capability reporting corresponding to the current power class (e.g., the power class resulting from the power class fallback). In some examples, the changes to the uplink transmission capabilities of the UE may depend on how the UE performs the fallback from the higher power class to the lower power class. For example, different modes for performing the power class fallback may be possible, and the different modes for performing the power class fallback may result in different changes to uplink transmission capabilities (e.g., MIMO transmission capabilities and/or full power transmission capabilities, among other examples) of the UE. The network node, when performing scheduling of uplink communications to be transmitted by the UE, may not be aware of the mode used by the UE to perform the power class fallback and/or the change in the uplink transmission capabilities of the UE resulting from the power class fallback. This may result in decreased network performance, including increased traffic latency and decreased network reliability.

Various aspects relate generally to a UE switching from one power class to another power class. Some aspects more specifically relate to power class switching modes (e.g., power class fallback modes) and uplink transmission capabilities associated with the power class switching modes. In some aspects, a UE may transmit, to a network node, capability information indicating a set of uplink transmission capabilities for the UE. The UE may transmit, to the network node, an indication of a power class switch from a first power class to a second power class. For example, the power class switch may be a power class fallback from a first power class associated with a first uplink transmission power to a second power class associated with a second uplink transmission power that is lower than the first uplink transmission power. The UE may transmit, to the network node, an indication of a power class switching mode associated with the power class switch, and the UE may transmit an uplink transmission based at least in part on one or more revised uplink transmission capabilities, from the set of uplink transmission capabilities, associated with the power class switching mode. In this way, scheduling of uplink transmissions may be improved, resulting in improved network performance, included decreased traffic latency and increased network reliability.

FIGS. 4A-4C are diagrams illustrating examples 400, 410, and 420 of power class fallback modes, in accordance with the present disclosure. The power class fallback modes correspond to different ways in which a UE may implement a power class fallback from a higher power class to a lower power class. For example, the power class fallback modes may be used by a UE to perform a power class fallback from PC2 to PC3, a power class fallback from PC1.5 to PC3, or a power class fallback from PC1.5 to PC2, among other examples. More generally, the power class fallback modes, which may also be referred to as “power class switching modes,” may correspond to ways in which a UE may switch from a first power class to a second power class. For example, each power class fallback mode (or power class switching mode) may be used by a UE to switch (e.g., fallback) from a higher power class to a lower class or to switch from a lower power class to a higher power class (e.g., to return to operating using the higher power class after a power class fallback).

FIG. 4A shows an example 400 of a first power class fallback mode (or first power class switching mode), referred to herein as “Fallback mode 1.” In Fallback mode 1, a UE may fall back from a higher power class to a lower power class by reducing a maximum transmission power across all of a set of power amplifiers (PAs) of the UE. That is, in Fallback mode 1, all PAs in a MIMO-capable UE may be dialed back by to a lower maximum transmission power such that the overall maximum transmission power of the UE is reduced from a first maximum transmission power associated with the higher power class to a second maximum transmission power associated with the lower power class. In some examples, In Fallback mode 1, the maximum transmission power of all of the PAs of the UE may be reduced by the same amount. As shown in FIG. 4A, a PC2 UE may have two PAs 402 (e.g., a first PA 402a and a second PA 402b) each with a maximum transmission power of 23 dBm (e.g., resulting in an overall maximum transmission power of 26 dBm when summed in the dBm domain). As further shown in FIG. 4A, the UE, to fallback to PC3 using Fallback mode 1, may reduce the maximum transmission power of each of the PAs 402 to 20 dBm, resulting in an overall maximum transmission power of 23 dBm. In some aspects, Fallback mode 1 may be similarly applied to switch from a lower power class to a higher power class by increasing the maximum transmission power across all of the PAs of the UE.

FIG. 4B shows an example 410 of a second power class fallback mode (or second power class switching mode), referred to herein as “Fallback mode 2.” In Fallback mode 2, a UE may fall back from a higher power class to a lower power class by deactivating a subset of one or more PAs from the set of PAs of the UE. That is, in Fallback mode 2, some PAs (e.g., a first subset) in a MIMO-capable UE may be deactivated and only the remaining PAs (e.g., a second subset) may be used by the UE. For example, as shown in FIG. 4B, a PC2 UE having two PAs 402 (e.g., a first PA 402a and a second PA 402b) each with a maximum transmission power of 23 dBm (e.g., resulting in an overall maximum transmission power of 26 dBm when summed in the dBm domain) may fall back to PC3 by deactivating the first PA 402a and transmitting using only the second PA 402b with the maximum transmission power of 23 dBm. In some aspects, Fallback mode 2 may be similarly applied to switch from a lower power class to a higher power class by activating (e.g., reactivating) a subset of one or more deactivated PA among the set of PAs of the UE.

FIG. 4C shows an example 420 of a third power class fallback mode (or third power class switching mode), referred to herein as “Fallback mode 3.” In Fallback mode 3, a UE may fall back from a higher power class to a lower power class by applying a reduced (e.g., tighter) sum-power constraint across the set of PAs and/or transmit (Tx) chains of the UE. The sum-power constraint may be a constraint on the sum (e.g., in the dBm domain) of the maximum transmission powers of the PAs of the UE. For example, the sum-power constraint may be equal to the maximum transmission power associated with the lower power class. That is, in Fallback mode 3, the UE may adjust the maximum transmission powers of the PAs in any combination that results in the sum of the maximum transmission powers of the PAs satisfying (e.g., being less than or equal to) the maximum transmission power associated with the lower power class. For example, as shown in FIG. 4C, a PC2 UE may have two PAs 402 (e.g., a first PA 402a and a second PA 402b) each with a maximum transmission power of 23 dBm (e.g., resulting in an overall maximum transmission power of 26 dBm when summed in the dBm domain) may fall back to PC3 by setting a maximum transmission power of the first PA 402a to x dBm and the maximum transmission power of the second PA 402b to y dBm, where x+y≤23 dBm. The UE may draw power from one of the PAs 402 or split power equally across the two PAs 402. For example, the UE may draw all of the power from the first PA 402a by setting x=23, the UE may draw all of the power from the second PA 402b by setting y=23, or the UE may split the power across the PAs 402 by setting x=20 and y=20. In some aspects, Fallback mode 3 may be similarly applied to switch from a lower power class to a higher power class by applying an increased sum-power constraint associated with the higher power class.

A power class switch (e.g., a power class fallback) using the different power class fallback modes may have impacts on uplink transmission capabilities of a UE. In some examples, Fallback mode 1 and Fallback mode 3 may not impact MIMO transmission capabilities (e.g., a MIMO coherence capability, a number of MIMO layers for codebook-based uplink transmission, and/or a number of MIMO layers for non-codebook-based uplink transmission, among other examples) of the UE. However, Fallback mode 1 and Fallback mode 3 may impact the capability of the UE to transmit at full power using a subset of PAs. Accordingly, in some aspects, one or more revised full power transmission capabilities (e.g., ul-FullPwrMode-r16, ul-FullPwrMode1-r16, ul-FullPwrMode2-MaxSRS-ResInSet-r16, ul-FullPwrMode2-SRSConfig-diffNumSRSPorts-r16, and/or ul-FullPwrMode2-TPMIGroup-r16, among other examples) may be associated with Fallback mode 1 or Fallback mode 3. In some examples, Fallback mode 2 may impact the MIMO transmission capabilities of the UE. Accordingly, in some aspects, one or more revised MIMO transmission capabilities (e.g., a MIMO coherence capability, a number of MIMO layers for codebook-based uplink transmission, and/or a number of MIMO layers for non-codebook-based uplink transmission, among other examples) may be associated with Fallback mode 2. Fallback mode 2 may also impact the full power transmission capability of the UE 120 due to fewer number of active PAs being used by the UE 120. Accordingly, in some aspects, one or more revised full power transmission capabilities (e.g., ul-FullPwrMode-r16, ul-FullPwrMode1-r16, ul-FullPwrMode2-MaxSRS-ResInSet-r16, ul-FullPwrMode2-SRSConfig-diffNumSRSPorts-r16, and/or ul-FullPwrMode2-TPMIGroup-r16, among other examples) may be associated with Fallback mode 2.

As indicated above, FIG. 4 is provided as an example. Other examples may differ from what is described with respect to FIG. 4.

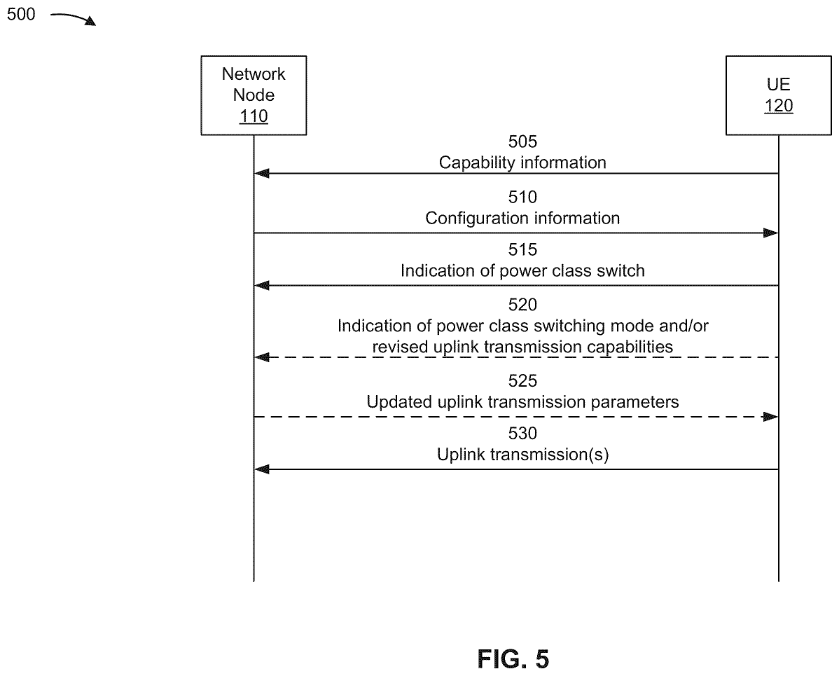

FIG. 5 is a diagram of an example 500 associated with power class switching modes, in accordance with the present disclosure. As shown in FIG. 5, a network node 110 may communicate with a UE 120. In some aspects, the network node 110 and the UE 120 may be part of a wireless network (e.g., wireless network 100). The UE 120 and the network node 110 may have established a wireless connection prior to operations shown in FIG. 5.

As shown by reference number 505, the UE 120 may transmit, and the network node 110 may receive, capability information. For example, the UE may transmit, and the network node 110 may receive, a capability report including the capability information. In some aspects, the capability information may include an indication of a power class supported by the UE 120. For example, the capability information may indicate a highest power class supported by the UE 120. In some aspects, the capability information may indicate that the UE 120 supports a power class associated with a higher maximum uplink transmission power than a default power class. For example, the capability information may indicate that the UE 120 supports PC2 (e.g., the UE 120 is a PC2 UE) or PC1.5 (e.g., the UE 120 is a PC1.5 UE). In some examples, the capability information may include an indication of a maximum duty cycle (e.g., maxUplinkDutyCycle-PC2-FR1 or maxUplinkDutyCycle-PC1dot5-MPE-FR1) associated with the power class (e.g., PC2 or PC1.5) supported by the UE 120. In some examples, if the indication of the maximum duty cycle (e.g., maxUplinkDutyCycle-PC2-FR1 or maxUplinkDutyCycle-PC1dot5-MPE-FR1) is not included in the configuration information, a default maximum duty cycle (e.g., 50%) may be applied.

In some aspects, the capability information may indicate a set of uplink transmission capabilities associated with the UE 120. In some aspects, the set of uplink transmission capabilities may include MIMO transmission capabilities of the UE 120. For example, the MIMO transmission capabilities may include a MIMO coherence capability (e.g., a physical uplink shared channel (PUSCH) codebook coherency subset), a supported number of layers for codebook-based uplink (e.g., PUSCH) MIMO transmission, and/or a supported number of layers for non-codebook-based uplink (e.g., PUSCH) transmission, among other examples. In some aspects, the set of uplink transmission capabilities may include full power transmission capabilities (e.g., ul-FullPwrMode-r16, ul-FullPwrMode1-r16, ul-FullPwrMode2-MaxSRS-ResInSet-r16, ul-FullPwrMode2-SRSConfig-diffNumSRSPorts-r16, and/or ul-FullPwrMode2-TPMIGroup-r16, among other examples) of the UE 120. In some aspects, the set of uplink transmission capabilities indicated in the capability information may correspond to uplink transmission capabilities for a normal mode of operation of the UE 120 (e.g., without a power class fallback). For example, the normal mode of operation of the UE 120 may be associated with the power class (e.g., the highest power class) supported by the UE 120.

In some aspects, the capability information may indicate one or more power class switching modes (e.g., power class fallback modes) supported by the UE 120. For example, the one or more power class switching modes may include one or more of a first power class fallback mode (e.g., Fallback mode 1 discussed in connection with FIG. 4A) associated with reducing a maximum transmission power across all of a set of power amplifiers of the UE 120, a second power class fallback mode (e.g., Fallback mode 2 discussed in connection with FIG. 4B) associated with deactivating a subset of the set of power amplifiers of the UE 120, or a third power class fallback mode (e.g., Fallback mode 3 discussed in connection with FIG. 4C). Additionally, or alternatively, the one or more power class switching modes may include one or more other power class switching or fallback modes.

In some aspects, the capability information may include an indication of a power class switching mode associated with a power class switch by the UE 120. For example, the UE 120 may include, in the capability information, a static indication of a power class switching mode (e.g., a power class fallback mode) to be used by the UE 120 for a power class switch from one power class to another power class. In such examples, the power class switching mode indicated in the capability information may be used by the UE 120 for a power class switch (e.g., fallback) from a higher power class (e.g., PC2 or PC1.5) to a lower power class (e.g., PC3) and for a power class switch from a lower power class to a higher power class (e.g., when returning to the higher power class after a power class fallback). For example, the power class switching mode indicated in the capability information Fallback mode 1, Fallback mode 2, or Fallback mode 3.

In some aspects, the capability information may indicate one or more revised uplink transmission capabilities associated with at least one power class switching mode. For example, in a case in which the capability information includes the static indication of the power class switching mode to be used by the UE 120 for performing power class switching, the capability information may also indicate one or more revised uplink transmission capabilities associated with the indicated power class switching mode. The one or more revised uplink transmission capabilities may include revised values for one or more of the uplink transmission capabilities included in the set of uplink transmission capabilities (e.g., the set of uplink transmission capabilities associated with normal operation of the UE 120). For example, the one or more revised uplink transmission capabilities may include at least one of a full power transmission capability, a MIMO coherence capability, a supported number of MIMO layers for codebook-based uplink transmission, or a supported number of MIMO layers in non-codebook-based uplink transmission.

In some aspects, the capability information may indicate multiple sets of uplink transmission capabilities. For example, the capability information may include a first set of uplink transmission capabilities associated with operation of the UE 120 without a power class fallback, and a respective second set of uplink transmission capabilities associated with each of one or more power class fallback modes (e.g., power class switching modes). The first set of uplink transmission capabilities may include one or more MIMO transmission capabilities and/or one or more full power transmission capabilities, among other examples, as discussed above. Each respective second set of uplink transmission capabilities may include one or more revised uplink transmission capabilities, from among the uplink transmission capabilities included in the first set of uplink transmission capabilities, that are associated with the corresponding power class fallback mode. In some examples, the capability information may include a respective second set of uplink transmission capabilities for each of multiple power class fallback modes (e.g., power class switching modes) supported by the UE 120. For example, the capability information may include a set of uplink transmission capabilities associated with a normal mode of operation of the UE 120 (e.g., operation without a power class fallback), and the capability information may also include a set of uplink transmission capabilities associated with Fallback mode 1, a set of uplink transmission capabilities associated with Fallback mode 2, and/or a set of uplink transmission capabilities associated with Fallback mode 3.

As further shown in FIG. 5, and by reference number 510, the network node 110 may transmit, and the UE 120 may receive, configuration information. In some aspects, the UE 120 may receive the configuration information via one or more RRC messages. Additionally, or alternatively, the UE 120 may receive the configuration information via system information (e.g., a master information block (MIB) and/or a system information block (SIB), among other examples), one or more MAC control elements (MAC-CEs), and/or downlink control information (DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may indicate a configuration of one or more uplink transmission parameters for the UE 120. For example, the uplink transmission parameters may include parameters associated with PUSCH transmissions, physical uplink control channel (PUCCH) transmissions, and/or uplink reference signal (e.g., sounding reference signal (SRS)) transmissions to be performed by the UE 120. The configuration of the one or more uplink transmission parameters may be based at least in part on the capability information transmitted from the UE 120 to the network node 110. For example, the configuration of the one or more uplink transmission parameters may be based at least in part on the set of uplink transmission capabilities indicated in capability information. In some aspects, the one or more uplink transmission parameters may include a parameter associated with MIMO coherence, a parameter indicating a number of MIMO layers for codebook-based uplink transmission, a parameter indicating a number of MIMO layers for non-codebook-based uplink transmission, and/or parameters associated with one or more full power transmission modes (e.g., indicating whether the one or more full power transmission modes are enabled for the UE 120).

In some aspects, the configuration information may indicate a power class switching mode (e.g., a power class fallback mode) to be used by the UE 120 for power class switching (e.g., fallback from and higher power class to a lower power class and/or switching from a lower power class to a higher power class). For example, the network node 110 may select a power class fallback mode to be used by the UE 120 from one or more supported power class fallback modes indicated in the capability information, and the configuration information may include an indication of the selected power class fallback mode. In some aspects, the configuration information may indicate one or more disallowed power class switching modes that the UE 120 is not permitted to use. For example, the network node 110 may determine one or more disallowed power class fallback modes from among one or more supported power class fallback modes indicated in the capability information, and the configuration information may include an indication of the one or more disallowed power class fallback modes.

In some aspects, the configuration information may indicate a respective configuration, of the one or more uplink transmission parameters, for each of one or more power class switching modes (e.g., power class fallback modes). For example, the configuration information may indicate a respective configuration (e.g., a respective RRC configuration), of the one or more uplink transmission parameters, for each of one or more supported power class fallback modes indicated in the capability information. In some examples, the respective configuration for each supported power class fallback mode may be based at least in part on a respective set of uplink transmission capabilities for each support power class fallback mode included in the capability information.

As further shown in FIG. 5, and by reference number 515, the UE 120 may transmit, and the network node 110 may receive, an indication of a power class switch from a first power class associated with a first uplink transmission power (e.g., a first maximum uplink transmission power) to a second power class associated with a second uplink transmission power (e.g., a second maximum uplink transmission power). In some aspects, the indication of the power class switch may be included in a PHR transmitted from the UE 120 to the network node 110. For example, the PHR may include a parameter (e.g., 4P PowerClass) that indicates a switch from one power class to another power class. In some aspects, the UE 120 may transmit the indication of the power class switch based at least in part on a determination to switch power classes from the first power class to a second power class and/or based at least in part on performing the power class switch. The UE 120 may perform the power class switch using a power class switching mode (e.g., a power class fallback mode) associated with the power class switch. For example, the UE 120 may perform the power class switch using Fallback mode 1, Fallback mode 2, or Fallback mode 3.

In some aspects, the power class switch may be a power class fallback from a first power class associated with a first maximum transmission power to a second power class associated with a second maximum transmission power that is lower than the first maximum transmission power. In such examples, the UE 120 may perform the power class fallback from the first power class to the second power class and transmit the indication of the power class fallback based at least in part on a determination that a number of uplink transmissions scheduled for the UE 120 exceed the maximum duty cycle associated with the first power class. For example, the power class fallback may be a power class fallback from PC2 to PC3, a power class fallback from PC1.5 to PC3, or a power class fallback from PC1.5 to PC2.

In some aspects, the power class switch may be a switch from a first power associated with a first maximum transmission power to a second power class associated with a second maximum transmission power that is higher than the first maximum transmission power. For example, the UE 120 may perform the power class switch, after a previous power class fallback from the second power class to the first power class, to return to the second power class. In such examples, the UE 120 may perform the power class switch from the first power class to the second power class and transmit the indication of the power class switch based at least in part a determination that a triggering condition associated with ending a power class fallback has been satisfied. For example, the power class switch may be a switch from PC3 to PC2, a switch from PC3 to PC1.5, or a switch from PC2 to PC1.5.

As further shown in FIG. 5, and by reference number 520, the UE 120 may transmit, and the network node 110 may receive, an indication of the power class switching mode associated with the power class switch and/or an indication of one or more revised uplink transmission capabilities associated with the power class switching mode. In some aspects, as discussed above, the indication of the power class switching mode associated with the power class switch may be included in the capability information. For example, the capability information may include a static indication and the power class switching mode (e.g., power class fallback mode) to be used by the UE 120 for power class switches.

In some other aspects, the UE 120 may dynamically indicate the power class switching mode associated with the power class switch. For example, the UE 120 may dynamically indicated the power class switching mode used for the power class switch each time the UE 120 performs a power class switch. In such examples, the indication of the power class switching mode associated with the power class switch may be included in a same transmission as the indication of the power class switch. For example, the UE 120 may transmit, and the network node 110 may receive, a PHR that includes the indication of the power class switch and the indication of the power class switching mode (e.g., power class fallback mode) associated with the power class switch. In some aspects, the indication of the power class switching mode may be an indication of a selected power class switching mode (e.g., a selected power class fallback mode) from one or more supported power class switching modes (e.g., supported power class fallback modes) indicated in the capability information.

In some aspects, as discussed above, the one or more revised uplink transmission capabilities associated with the power class switching mode may be indicated in the capability information. In some examples, the capability information may indicate the one or more revised uplink transmission capabilities associated with a selected power class switching mode indicated in the capability information. In some other examples, the capability information may indicate respective sets of uplink transmission capabilities, each indicating one or more respective revised uplink transmission capabilities, for each of one or more supported power class switching modes.

In some other aspects, the one or more revised uplink transmission capabilities associated with the power class switching mode may be dynamically indicated by the UE 120. In such examples, the one or more revised uplink transmission capabilities associated with the power class switching mode may be included in a same transmission as the indication of the power class switch. For example, the UE 120 may transmit, and the network node 110 may receive a PHR that includes the indication of the power class switch and the indication of the one or more revised uplink transmission associated with the power class switching mode associated with the power class switch. In some examples, the PHR may also include the indication of the power class switching mode associated with the power class switch.

As further shown in FIG. 5, and by reference number 525, in some aspects, the network node 110 may transmit, and the UE 120 may receive, an indication of one or more updated uplink transmission parameters. As discussed above, in some aspects, the configuration information may indicate a respective configuration of one or more uplink transmission parameters for each of one or more power class switching modes (e.g., power class fallback modes) indicated in the capability information. In some other aspects, the configuration information may include a configuration of a set of uplink transmission parameters for the UE 120, and the network node 110 may transmit, to the UE 120, an indication of one or more updated uplink transmission parameters, of the set of uplink transmission parameters, based at least in part on receiving the indication of the power class switch and based at least in part on the power class switching mode associated with the power class switch. For example, the indication of the one or more updated uplink transmission parameters may be included in a MAC-CE transmitted by the network node 110. In such examples, in connection with receiving the indication of the power class switch (e.g., in the PHR transmitted by the UE 120), the network node 110 may determine the one or more updated uplink transmission parameters for the UE 120 based at least in part on the one or more revised uplink transmission capabilities associated with the power class switching mode associated with the power class switch. For example, the network node 110 may determine whether a particular full power transmission mode is to be enabled or not for the UE 120 based at least in part on the one or more revised uplink transmission capabilities. In some examples, the one or more updated transmission parameters may include at least one of a parameter associated with MIMO coherence, a parameter indicating a number of MIMO layers for codebook-based uplink transmission, a parameter indicating a number of MIMO layers for non-codebook-based uplink transmission, or a parameter associated with a full power transmission mode.

As further shown in FIG. 5, and by reference number 530, the UE 120 may transmit, and the network node 110 may receive, one or more uplink transmissions based at least in part on the one or more revised uplink transmission capabilities associated with the power class switching mode associated with the power class switch. The one or more uplink transmissions may include one or more PUSCH transmissions, one or more PUCCH transmission, and/or one or more uplink reference signals (e.g., SRS) transmissions. In some aspects, the UE 120 may transmit the one or more uplink transmissions in accordance with one or more uplink transmission parameters configured based at least in part on the one or more revised uplink transmission capabilities associated with the power class switching mode. In some examples, the UE 120 may transmit the one or more uplink transmissions based at least in part on a configuration, included in the configuration information, of one or more uplink transmission parameters associated with the power class switching mode. In some other examples, the UE 120 may transmit the one or more uplink transmissions based at least in part on the one or more updated transmission parameters indicated in the indication of one or more updated transmission parameters received from the network node 110.

As indicated above, FIG. 5 is provided as an example. Other examples may differ from what is described with respect to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with power class switching modes.

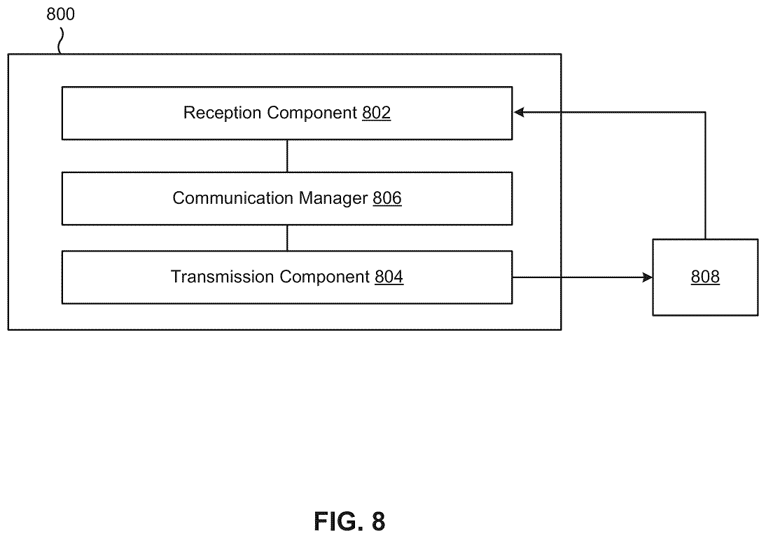

As shown in FIG. 6, in some aspects, process 600 may include transmitting, to a network node, capability information indicating a set of uplink transmission capabilities (block 610). For example, the UE (e.g., using transmission component 804 and/or communication manager 806, depicted in FIG. 8) may transmit, to a network node, capability information indicating a set of uplink transmission capabilities, as described above.

As further shown in FIG. 6, in some aspects, process 600 may include transmitting, to the network node, an indication of a power class switch from a first power class associated with a first uplink transmission power to a second power class associated with a second uplink transmission power (block 620). For example, the UE (e.g., using transmission component 804 and/or communication manager 806, depicted in FIG. 8) may transmit, to the network node, an indication of a power class switch from a first power class associated with a first uplink transmission power to a second power class associated with a second uplink transmission power, as described above.

As further shown in FIG. 6, in some aspects, process 600 may include transmitting, to the network node, an indication of a power class switching mode associated with the power class switch (block 630). For example, the UE (e.g., using transmission component 804 and/or communication manager 806, depicted in FIG. 8) may transmit, to the network node, an indication of a power class switching mode associated with the power class switch, as described above.

As further shown in FIG. 6, in some aspects, process 600 may include transmitting, to the network node, an uplink transmission based at least in part on one or more revised uplink transmission capabilities, from the set of uplink transmission capabilities, associated with the power class switching mode (block 640). For example, the UE (e.g., using transmission component 804 and/or communication manager 806, depicted in FIG. 8) may transmit, to the network node, an uplink transmission based at least in part on one or more revised uplink transmission capabilities, from the set of uplink transmission capabilities, associated with the power class switching mode, as described above.

Process 600 may include additional aspects, such as any single aspect or any combination of aspects described below and/or in connection with one or more other processes described elsewhere herein.

In a first aspect, the power class switching mode is one of a first power class fallback mode associated with reducing a maximum transmission power across all of a set of power amplifiers of the UE, a second power class fallback mode associated with deactivating a subset of the set of power amplifiers of the UE, or a third power class fallback mode associated with applying a reduced sum-power constraint across the set of power amplifiers of the UE.

In a second aspect, alone or in combination with the first aspect, the one or more revised uplink transmission capabilities include at least one of a full power transmission capability, a MIMO coherence capability, a supported number of MIMO layers in codebook-based uplink transmission, or a supported number of MIMO layers in non-codebook-based uplink transmission.

In a third aspect, alone or in combination with one or more of the first and second aspects, the indication of the power class switching mode is included in the capability information.

In a fourth aspect, alone or in combination with one or more of the first through third aspects, the indication of the power class switching mode is included in a same transmission as the indication of the power class switch.

In a fifth aspect, alone or in combination with one or more of the first through fourth aspects, the one or more revised uplink transmission capabilities associated with the power class switching mode are indicated in the capability information.

In a sixth aspect, alone or in combination with one or more of the first through fifth aspects, the capability information includes a first set of uplink transmission capabilities associated with operation without a power class fallback, and a respective second set of uplink transmission capabilities associated with each of one or more power class fallback modes, the power class switching mode is a power class fallback mode of the one or more power class fallback modes, and for each power class fallback mode, of the one or more power class fallback modes, the respective second set of uplink transmission capabilities indicates one or more revised uplink transmission capabilities from the first set of uplink transmission capabilities.

In a seventh aspect, alone or in combination with one or more of the first through sixth aspects, the one or more power class fallback modes include a first power class fallback mode associated with reducing a maximum transmission power across all of a set of power amplifiers of the UE, a second power class fallback mode associated with deactivating a subset of the set of power amplifiers of the UE, and a third power class fallback mode associated with applying a sum-power constraint associated with the second power class across the set of power amplifiers of the UE.

In an eighth aspect, alone or in combination with one or more of the first through seventh aspects, process 600 includes receiving, based at least in part on the capability information, configuration information indicating a respective configuration of one or more uplink transmission parameters associated with each of the one or more power class fallback modes, wherein transmitting the uplink transmission includes transmitting the uplink transmission based at least in part on the respective configuration of the one or more uplink transmission parameters associated with the power class fallback mode.

In a ninth aspect, alone or in combination with one or more of the first through eighth aspects, an indication of the one or more revised uplink transmission capabilities is included in a same communication as the indication of the power class switch.

In a tenth aspect, alone or in combination with one or more of the first through ninth aspects, process 600 includes receiving, based at least in part on the capability information, configuration information indicating a configuration of a set of uplink transmission parameters, and receiving, based at least in part on the indication of the power class switch and the indication of the power class switching mode, an indication of one or more updated uplink transmission parameters, of the set of uplink transmission parameters, associated with the one or more revised uplink transmission capabilities, wherein transmitting the uplink transmission includes transmitting the uplink transmission based at least in part on the one or more updated uplink transmission parameters.

In an eleventh aspect, alone or in combination with one or more of the first through tenth aspects, process 600 includes receiving, from the network node, configuration information indicating the power class switching mode.

In a twelfth aspect, alone or in combination with one or more of the first through eleventh aspects, process 600 includes receiving, from the network node, configuration information indicating a disallowed power class switching mode.

In a thirteenth aspect, alone or in combination with one or more of the first through twelfth aspects, the second uplink transmission power is lower than the first uplink transmission power, and the power class switch is a power class fallback from the first power class to the second power class.

In a fourteenth aspect, alone or in combination with one or more of the first through thirteenth aspects, the first power class is a PC2 and the second power class is a PC3.

In a fifteenth aspect, alone or in combination with one or more of the first through fourteenth aspects, the indication of the power class switching mode indicates whether a maximum transmission power is reduced across all of a set of power amplifiers of the UE.

In a sixteenth aspect, alone or in combination with one or more of the first through fifteenth aspects, the indication of the power class switch and the indication of the power class switching mode are included in a PHR.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with power class switching modes.

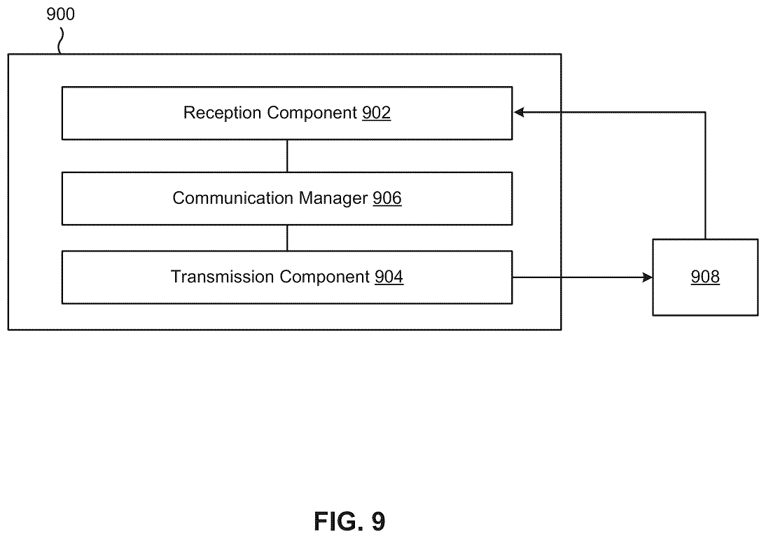

As shown in FIG. 7, in some aspects, process 700 may include receiving, from a UE, capability information indicating a set of uplink transmission capabilities (block 710). For example, the network node (e.g., using reception component 902 and/or communication manager 906, depicted in FIG. 9) may receive, from a UE, capability information indicating a set of uplink transmission capabilities, as described above.

As further shown in FIG. 7, in some aspects, process 700 may include receiving, from the UE, an indication of a power class switch from a first power class associated with a first uplink transmission power to a second power class associated with a second uplink transmission power (block 720). For example, the network node (e.g., using reception component 902 and/or communication manager 906, depicted in FIG. 9) may receive, from the UE, an indication of a power class switch from a first power class associated with a first uplink transmission power to a second power class associated with a second uplink transmission power, as described above.

As further shown in FIG. 7, in some aspects, process 700 may include receiving, from the UE, an indication of a power class switching mode associated with the power class switch (block 730). For example, the network node (e.g., using reception component 902 and/or communication manager 906, depicted in FIG. 9) May receive, from the UE, an indication of a power class switching mode associated with the power class switch, as described above.

As further shown in FIG. 7, in some aspects, process 700 may include receiving, from the UE, an uplink transmission based at least in part on one or more revised uplink transmission capabilities, from the set of uplink transmission capabilities, associated with the power class switching mode (block 740). For example, the network node (e.g., using reception component 902 and/or communication manager 906, depicted in FIG. 9) may receive, from the UE, an uplink transmission based at least in part on one or more revised uplink transmission capabilities, from the set of uplink transmission capabilities, associated with the power class switching mode, as described above.

Process 700 may include additional aspects, such as any single aspect or any combination of aspects described below and/or in connection with one or more other processes described elsewhere herein.

In a first aspect, the power class switching mode is one of a first power class fallback mode associated with reducing a maximum transmission power across all of a set of power amplifiers of the UE, a second power class fallback mode associated with deactivating a subset of the set of power amplifiers of the UE, or a third power class fallback mode associated with applying a reduced sum-power constraint across the set of power amplifiers of the UE.

In a second aspect, alone or in combination with the first aspect, the one or more revised uplink transmission capabilities include at least one of a full power transmission capability, a MIMO coherence capability, a supported number of MIMO layers in codebook-based uplink transmission, or a supported number of MIMO layers in non-codebook-based uplink transmission.

In a third aspect, alone or in combination with one or more of the first and second aspects, the indication of the power class switching mode is included in the capability information.

In a fourth aspect, alone or in combination with one or more of the first through third aspects, the indication of the power class switching mode is included in a same transmission as the indication of the power class switch.

In a fifth aspect, alone or in combination with one or more of the first through fourth aspects, the one or more revised uplink transmission capabilities associated with the power class switching mode are indicated in the capability information.

In a sixth aspect, alone or in combination with one or more of the first through fifth aspects, the capability information includes a first set of uplink transmission capabilities associated with operation without a power class fallback, and a respective second set of uplink transmission capabilities associated with each of one or more power class fallback modes, the power class switching mode is a power class fallback mode of the one or more power class fallback modes, and for each power class fallback mode, of the one or more power class fallback modes, the respective second set of uplink transmission capabilities indicates one or more revised uplink transmission capabilities from the first set of uplink transmission capabilities.

In a seventh aspect, alone or in combination with one or more of the first through sixth aspects, the one or more power class fallback modes include a first power class fallback mode associated with reducing a maximum transmission power across all of a set of power amplifiers of the UE, a second power class fallback mode associated with deactivating a subset of the set of power amplifiers of the UE, and a third power class fallback mode associated with applying a sum-power constraint associated with the second power class across the set of power amplifiers of the UE.

In an eighth aspect, alone or in combination with one or more of the first through seventh aspects, process 700 includes transmitting, based at least in part on the capability information, configuration information indicating a respective configuration of one or more uplink transmission parameters associated with each of the one or more power class fallback modes, wherein receiving the uplink transmission includes receiving the uplink transmission based at least in part on the respective configuration of the one or more uplink transmission parameters associated with the power class fallback mode.

In a ninth aspect, alone or in combination with one or more of the first through eighth aspects, an indication of the one or more revised uplink transmission capabilities is included in a same communication as the indication of the power class switch.

In a tenth aspect, alone or in combination with one or more of the first through ninth aspects, process 700 includes transmitting, based at least in part on the capability information, configuration information indicating a configuration of a set of uplink transmission parameters, and transmitting, based at least in part on the indication of the power class switch and the indication of the power class switching mode, an indication of one or more updated uplink transmission parameters, of the set of uplink transmission parameters, associated with the one or more revised uplink transmission capabilities, wherein receiving the uplink transmission includes receiving the uplink transmission based at least in part on the one or more updated uplink transmission parameters.

In an eleventh aspect, alone or in combination with one or more of the first through tenth aspects, process 700 includes transmitting, to the UE, configuration information indicating the power class switching mode.

In a twelfth aspect, alone or in combination with one or more of the first through eleventh aspects, process 700 includes transmitting, to the UE, configuration information indicating a disallowed power class switching mode.

In a thirteenth aspect, alone or in combination with one or more of the first through twelfth aspects, the second uplink transmission power is lower than the first uplink transmission power, and the power class switch is a power class fallback from the first power class to the second power class.

In a fourteenth aspect, alone or in combination with one or more of the first through thirteenth aspects, the first power class is a PC2 and the second power class is a PC3.

In a fifteenth aspect, alone or in combination with one or more of the first through fourteenth aspects, the indication of the power class switching mode indicates whether a maximum transmission power is reduced across all of a set of power amplifiers of the UE.

In a sixteenth aspect, alone or in combination with one or more of the first through fifteenth aspects, the indication of the power class switch and the indication of the power class switching mode are included in a PHR.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 4A-4C and 5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit, to a network node, capability information indicating a set of uplink transmission capabilities. The transmission component 804 may transmit, to the network node, an indication of a power class switch from a first power class associated with a first uplink transmission power to a second power class associated with a second uplink transmission power. The transmission component 804 may transmit, to the network node, an indication of a power class switching mode associated with the power class switch. The transmission component 804 may transmit, to the network node, an uplink transmission based at least in part on one or more revised uplink transmission capabilities, from the set of uplink transmission capabilities, associated with the power class switching mode.

The reception component 802 may receive, based at least in part on the capability information, configuration information indicating a respective configuration of one or more uplink transmission parameters associated with each of the one or more power class fallback modes, and the transmission component 804 may transmit the uplink transmission based at least in part on the respective configuration of the one or more uplink transmission parameters associated with the power class fallback mode.

The reception component 802 may receive, based at least in part on the capability information, configuration information indicating a configuration of a set of uplink transmission parameters.

The reception component 802 may receive, based at least in part on the indication of the power class switch and the indication of the power class switching mode, an indication of one or more updated uplink transmission parameters, of the set of uplink transmission parameters, associated with the one or more revised uplink transmission capabilities, and the transmission component 804 may transmit the uplink transmission based at least in part on the one or more updated uplink transmission parameters.

The reception component 802 may receive, from the network node, configuration information indicating the power class switching mode.

The reception component 802 may receive, from the network node, configuration information indicating a disallowed power class switching mode.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4A-4C and 5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a UE, capability information indicating a set of uplink transmission capabilities. The reception component 902 may receive, from the UE, an indication of a power class switch from a first power class associated with a first uplink transmission power to a second power class associated with a second uplink transmission power. The reception component 902 may receive, from the UE, an indication of a power class switching mode associated with the power class switch. The reception component 902 may receive, from the UE, an uplink transmission based at least in part on one or more revised uplink transmission capabilities, from the set of uplink transmission capabilities, associated with the power class switching mode.

The transmission component 904 may transmit, based at least in part on the capability information, configuration information indicating a respective configuration of one or more uplink transmission parameters associated with each of the one or more power class fallback modes, and the reception component 902 may receive the uplink transmission based at least in part on the respective configuration of the one or more uplink transmission parameters associated with the power class fallback mode.

The transmission component 904 may transmit, based at least in part on the capability information, configuration information indicating a configuration of a set of uplink transmission parameters.

The transmission component 904 may transmit, based at least in part on the indication of the power class switch and the indication of the power class switching mode, an indication of one or more updated uplink transmission parameters, of the set of uplink transmission parameters, associated with the one or more revised uplink transmission capabilities, and the reception component 902 may receive the uplink transmission based at least in part on the one or more updated uplink transmission parameters.

The transmission component 904 may transmit, to the UE, configuration information indicating the power class switching mode.

The transmission component 904 may transmit, to the UE, configuration information indicating a disallowed power class switching mode.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting, to a network node, capability information indicating a set of uplink transmission capabilities; transmitting, to the network node, an indication of a power class switch from a first power class associated with a first uplink transmission power to a second power class associated with a second uplink transmission power; transmitting, to the network node, an indication of a power class switching mode associated with the power class switch; and transmitting, to the network node, an uplink transmission based at least in part on one or more revised uplink transmission capabilities, from the set of uplink transmission capabilities, associated with the power class switching mode.

Aspect 2: The method of Aspect 1, wherein the power class switching mode is one of: a first power class fallback mode associated with reducing a maximum transmission power across all of a set of power amplifiers of the UE, a second power class fallback mode associated with deactivating a subset of the set of power amplifiers of the UE, or a third power class fallback mode associated with applying a reduced sum-power constraint across the set of power amplifiers of the UE.

Aspect 3: The method of any of Aspects 1-2, wherein the one or more revised uplink transmission capabilities include at least one of: a full power transmission capability, a multiple-input multiple-output (MIMO) coherence capability, a supported number of MIMO layers in codebook-based uplink transmission, or a supported number of MIMO layers in non-codebook-based uplink transmission.

Aspect 4: The method of any of Aspects 1-3, wherein the indication of the power class switching mode is included in the capability information.

Aspect 5: The method of any of Aspects 1-3, wherein the indication of the power class switching mode is included in a same transmission as the indication of the power class switch.

Aspect 6: The method of any of Aspects 1-5, wherein the one or more revised uplink transmission capabilities associated with the power class switching mode are indicated in the capability information.

Aspect 7: The method of any of Aspects 1-6, wherein the capability information includes: a first set of uplink transmission capabilities associated with operation without a power class fallback, and a respective second set of uplink transmission capabilities associated with each of one or more power class fallback modes, wherein the power class switching mode is a power class fallback mode of the one or more power class fallback modes, and wherein for each power class fallback mode, of the one or more power class fallback modes, the respective second set of uplink transmission capabilities indicates one or more revised uplink transmission capabilities from the first set of uplink transmission capabilities.

Aspect 8: The method of Aspect 7, wherein the one or more power class fallback modes include: a first power class fallback mode associated with reducing a maximum transmission power across all of a set of power amplifiers of the UE, a second power class fallback mode associated with deactivating a subset of the set of power amplifiers of the UE, and a third power class fallback mode associated with applying a sum-power constraint associated with the second power class across the set of power amplifiers of the UE.

Aspect 9: The method of any of Aspects 7-8, further comprising: receiving, based at least in part on the capability information, configuration information indicating a respective configuration of one or more uplink transmission parameters associated with each of the one or more power class fallback modes, wherein transmitting the uplink transmission comprises transmitting the uplink transmission based at least in part on the respective configuration of the one or more uplink transmission parameters associated with the power class fallback mode.

Aspect 10: The method of any of Aspects 1-5, wherein an indication of the one or more revised uplink transmission capabilities is included in a same communication as the indication of the power class switch.

Aspect 11: The method of any of Aspects 1-10, further comprising: receiving, based at least in part on the capability information, configuration information indicating a configuration of a set of uplink transmission parameters; and receiving, based at least in part on the indication of the power class switch and the indication of the power class switching mode, an indication of one or more updated uplink transmission parameters, of the set of uplink transmission parameters, associated with the one or more revised uplink transmission capabilities, wherein transmitting the uplink transmission comprises transmitting the uplink transmission based at least in part on the one or more updated uplink transmission parameters.

Aspect 12: The method of any of Aspects 1-11, further comprising: receiving, from the network node, configuration information indicating the power class switching mode.

Aspect 13: The method of any of Aspects 1-12, further comprising: receiving, from the network node, configuration information indicating a disallowed power class switching mode.

Aspect 14: The method of any of Aspects 1-13, wherein the second uplink transmission power is lower than the first uplink transmission power, and wherein the power class switch is a power class fallback from the first power class to the second power class.

Aspect 15: The method of any of Aspects 1-14, wherein the first power class is a power class 2 (PC2) and the second power class is a power class 3 (PC3).

Aspect 16: The method of any of Aspects 1-15, wherein the indication of the power class switching mode indicates whether a maximum transmission power is reduced across all of a set of power amplifiers of the UE.

Aspect 17: The method of any of Aspects 1-3 and 5-16, wherein the indication of the power class switch and the indication of the power class switching mode are included in a power headroom report (PHR).

Aspect 18: A method of wireless communication performed by a network node, comprising: receiving, from a user equipment (UE), capability information indicating a set of uplink transmission capabilities; receiving, from the UE, an indication of a power class switch from a first power class associated with a first uplink transmission power to a second power class associated with a second uplink transmission power; receiving, from the UE, an indication of a power class switching mode associated with the power class switch; and receiving, from the UE, an uplink transmission based at least in part on one or more revised uplink transmission capabilities, from the set of uplink transmission capabilities, associated with the power class switching mode.

Aspect 19: The method of Aspect 18, wherein the power class switching mode is one of: a first power class fallback mode associated with reducing a maximum transmission power across all of a set of power amplifiers of the UE, a second power class fallback mode associated with deactivating a subset of the set of power amplifiers of the UE, or a third power class fallback mode associated with applying a reduced sum-power constraint across the set of power amplifiers of the UE.

Aspect 20: The method of any of Aspects 18-19, wherein the one or more revised uplink transmission capabilities include at least one of: a full power transmission capability, a multiple-input multiple-output (MIMO) coherence capability, a supported number of MIMO layers in codebook-based uplink transmission, or a supported number of MIMO layers in non-codebook-based uplink transmission.

Aspect 21: The method of any of Aspects 18-20, wherein the indication of the power class switching mode is included in the capability information.

Aspect 22: The method of any of Aspects 18-20, wherein the indication of the power class switching mode is included in a same transmission as the indication of the power class switch.

Aspect 23: The method of any of Aspects 18-22, wherein the one or more revised uplink transmission capabilities associated with the power class switching mode are indicated in the capability information.

Aspect 24: The method of any of Aspects 18-23, wherein the capability information includes: a first set of uplink transmission capabilities associated with operation without a power class fallback, and a respective second set of uplink transmission capabilities associated with each of one or more power class fallback modes, wherein the power class switching mode is a power class fallback mode of the one or more power class fallback modes, and wherein for each power class fallback mode, of the one or more power class fallback modes, the respective second set of uplink transmission capabilities indicates one or more revised uplink transmission capabilities from the first set of uplink transmission capabilities.

Aspect 25: The method of Aspect 24, wherein the one or more power class fallback modes include: a first power class fallback mode associated with reducing a maximum transmission power across all of a set of power amplifiers of the UE, a second power class fallback mode associated with deactivating a subset of the set of power amplifiers of the UE, and a third power class fallback mode associated with applying a sum-power constraint associated with the second power class across the set of power amplifiers of the UE.

Aspect 26: The method of any of Aspects 24-25, further comprising: transmitting, based at least in part on the capability information, configuration information indicating a respective configuration of one or more uplink transmission parameters associated with each of the one or more power class fallback modes, wherein receiving the uplink transmission comprises receiving the uplink transmission based at least in part on the respective configuration of the one or more uplink transmission parameters associated with the power class fallback mode.

Aspect 27: The method of any of Aspects 18-22, wherein an indication of the one or more revised uplink transmission capabilities is included in a same communication as the indication of the power class switch.

Aspect 28: The method of any of Aspects 18-27, further comprising: transmitting, based at least in part on the capability information, configuration information indicating a configuration of a set of uplink transmission parameters; and transmitting, based at least in part on the indication of the power class switch and the indication of the power class switching mode, an indication of one or more updated uplink transmission parameters, of the set of uplink transmission parameters, associated with the one or more revised uplink transmission capabilities, wherein receiving the uplink transmission comprises receiving the uplink transmission based at least in part on the one or more updated uplink transmission parameters.

Aspect 29: The method of any of Aspects 18-28, further comprising: transmitting, to the UE, configuration information indicating the power class switching mode.

Aspect 30: The method of any of Aspects 18-29, further comprising: transmitting, to the UE, configuration information indicating a disallowed power class switching mode.

Aspect 31: The method of any of Aspects 18-30, wherein the second uplink transmission power is lower than the first uplink transmission power, and wherein the power class switch is a power class fallback from the first power class to the second power class.

Aspect 32: The method of any of Aspects 18-31, wherein the first power class is a power class 2 (PC2) and the second power class is a power class 3 (PC3).

Aspect 33: The method of any of Aspects 18-32, wherein the indication of the power class switching mode indicates whether a maximum transmission power is reduced across all of a set of power amplifiers of the UE.

Aspect 34: The method of any of Aspects 18-20 and 22-32, wherein the indication of the power class switch and the indication of the power class switching mode are included in a power headroom report (PHR).

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.

Aspect 36: An apparatus for wireless communication at a device, the apparatus comprising one or more memories and one or more processors coupled to the one or more memories, the one or more processors configured to cause the device to perform the method of one or more of Aspects 1-34.

Aspect 37: An apparatus for wireless communication, the apparatus comprising at least one means for performing the method of one or more of Aspects 1-34.

Aspect 38: A non-transitory computer-readable medium storing code for wireless communication, the code comprising instructions executable by one or more processors to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

Aspect 40: A device for wireless communication, the device comprising a processing system that includes one or more processors and one or more memories coupled with the one or more processors, the processing system configured to cause the device to perform the method of one or more of Aspects 1-34.

Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors coupled to the one or more memories, the one or more processors individually or collectively configured to:
transmit, to a network node, capability information indicating a set of uplink transmission capabilities;
transmit, to the network node, an indication of a power class switch from a first power class associated with a first uplink transmission power to a second power class associated with a second uplink transmission power;
transmit, to the network node, an indication of a power class switching mode associated with the power class switch; and
transmit, to the network node, an uplink transmission based at least in part on one or more revised uplink transmission capabilities, from the set of uplink transmission capabilities, associated with the power class switching mode.

2. The UE of claim 1, wherein the indication of the power class switching mode indicates whether a maximum transmission power is reduced across all of a set of power amplifiers of the UE.

3. The UE of claim 1, wherein the power class switching mode is one of:
a first power class fallback mode associated with reducing a maximum transmission power across all of a set of power amplifiers of the UE,
a second power class fallback mode associated with deactivating a subset of the set of power amplifiers of the UE, or
a third power class fallback mode associated with applying a reduced sum-power constraint across the set of power amplifiers of the UE.

4. The UE of claim 1, wherein the one or more revised uplink transmission capabilities include at least one of:
a full power transmission capability,
a multiple-input multiple-output (MIMO) coherence capability,
a supported number of MIMO layers in codebook-based uplink transmission, or
a supported number of MIMO layers in non-codebook-based uplink transmission.

5. The UE of claim 1, wherein the indication of the power class switching mode is included in a same transmission as the indication of the power class switch.

6. The UE of claim 1, wherein the indication of the power class switch and the indication of the power class switching mode are included in a power headroom report (PHR).

7. The UE of claim 1, wherein the one or more revised uplink transmission capabilities associated with the power class switching mode are indicated in the capability information.

8. The UE of claim 1, wherein an indication of the one or more revised uplink transmission capabilities is included in a same communication as the indication of the power class switch.

9. The UE of claim 1, wherein the one or more processors are further individually or collectively configured to:
receive, based at least in part on the capability information, configuration information indicating a configuration of a set of uplink transmission parameters; and
receive, based at least in part on the indication of the power class switch and the indication of the power class switching mode, an indication of one or more updated uplink transmission parameters, of the set of uplink transmission parameters, associated with the one or more revised uplink transmission capabilities, wherein the one or more processors, to transmit the uplink transmission, are individually or collectively configured to transmit the uplink transmission based at least in part on the one or more updated uplink transmission parameters.

10. The UE of claim 1, wherein the second uplink transmission power is lower than the first uplink transmission power, and wherein the power class switch is a power class fallback from the first power class to the second power class.

11. The UE of claim 1, wherein the first power class is a power class 2 (PC2) and the second power class is a power class 3 (PC3).

12. A network node for wireless communication, comprising:
one or more memories; and
one or more processors coupled to the one or more memories, the one or more processors individually or collectively configured to:
receive, from a user equipment (UE), capability information indicating a set of uplink transmission capabilities;
receive, from the UE, an indication of a power class switch from a first power class associated with a first uplink transmission power to a second power class associated with a second uplink transmission power;
receive, from the UE, an indication of a power class switching mode associated with the power class switch; and
receive, from the UE, an uplink transmission based at least in part on one or more revised uplink transmission capabilities, from the set of uplink transmission capabilities, associated with the power class switching mode.

13. The network node of claim 12, wherein the indication of the power class switching mode indicates whether a maximum transmission power is reduced across all of a set of power amplifiers of the UE.

14. The network node of claim 12, wherein the power class switching mode is one of:
a first power class fallback mode associated with reducing a maximum transmission power across all of a set of power amplifiers of the UE,
a second power class fallback mode associated with deactivating a subset of the set of power amplifiers of the UE, or
a third power class fallback mode associated with applying a reduced sum-power constraint across the set of power amplifiers of the UE.

15. The network node of claim 12, wherein the indication of the power class switching mode is included in a same transmission as the indication of the power class switch.

16. The network node of claim 12, wherein the indication of the power class switch and the indication of the power class switching mode are included in a power headroom report (PHR).

17. A method of wireless communication performed by a user equipment (UE), comprising:
transmitting, to a network node, capability information indicating a set of uplink transmission capabilities;
transmitting, to the network node, an indication of a power class switch from a first power class associated with a first uplink transmission power to a second power class associated with a second uplink transmission power;
transmitting, to the network node, an indication of a power class switching mode associated with the power class switch; and
transmitting, to the network node, an uplink transmission based at least in part on one or more revised uplink transmission capabilities, from the set of uplink transmission capabilities, associated with the power class switching mode.

18. The method of claim 17, wherein the indication of the power class switching mode indicates whether a maximum transmission power is reduced across all of a set of power amplifiers of the UE.

19. The method of claim 17, wherein the power class switching mode is one of:
a first power class fallback mode associated with reducing a maximum transmission power across all of a set of power amplifiers of the UE,
a second power class fallback mode associated with deactivating a subset of the set of power amplifiers of the UE, or
a third power class fallback mode associated with applying a reduced sum-power constraint across the set of power amplifiers of the UE.

20. The method of claim 17, wherein the indication of the power class switching mode is included in a same transmission as the indication of the power class switch.
